(19) United States
(12) Patent Application Publication
(10) Pub. No.: US 2025/0296404 A1
(43) Pub. Date: Sep. 25, 2025

(54) VEHICLE VENTILATION AIMING FACILITY

(71) Applicant: Bulletproof Property Management, LLC, Cheyenne, WY (US)

(72) Inventor: Bennet Langlotz, Dallas, TX (US)

(73) Assignee: Bulletproof Property Management, LLC, Cheyenne, WY (US)

(21) Appl. No.: 18/614,155

(22) Filed: Mar. 22, 2024

(51) Int. Cl. B60H 1/00; B60K 35/28; B60K 35/81; G06V 20/59

(52) U.S. Cl. CPC B60H 1/00985; B60K 35/28; B60K 35/81; B60H 1/00871; B60K 2360/148; B60K 2360/16; G06V 20/593

(57) ABSTRACT

A vehicle ventilation system has a frame and an aimable airflow source associated with the frame. The airflow source is operable to generate an airflow impingement point and is operable to direct the airflow impingement point over a range of airflow aiming directions. An occupant support surface is configured to position an occupant within the range of aiming directions, and an occupant interface device having a graphical display and an occupant input facility is provided. A controller is operably connected to the graphical display and to the airflow source. The graphical display may be operable to depict a representation of the occupant, and to depict a representation of the impingement point juxtaposed at a selected position on the representation of the occupant. A camera may be connected to the controller and the airflow impingement point on the occupant based at least in part on a camera image.

### FIELD OF THE INVENTION

The present invention relates to vehicle ventilation systems and more particularly to user interfaces and airflow aiming of such systems.

### BACKGROUND AND SUMMARY

Traditional vehicle ventilation systems have a number of ducts with vanes or louvers that create a directionalized airflow. These are aimed manually by the user to a desired aiming point to provide user comfort. Other systems employ motorized aiming features.

Advanced systems such as used on current vehicles by Tesla Inc. lack traditional ducts and vanes, and have aiming mechanisms that are internal to the dashboard and aimed by motorized internal elements that are controlled by a computer and user interface. The user control interface depicts a graphical representation of a dashboard control showing the ducts or airflow source locations on the dashboard in the context of steering wheel and displays, with the direction of the airflow shown by an animated graphic airstream originating at the duct, and spreading upward, downward, centrally, or to either side based on a selected setting of vertical aiming mechanism and lateral aiming mechanism. The graphic interface depiction may include horizontal and vertical bars each with a sliding marker indicating a aiming point on an imaginary orthogonal grid overlaid on the portion of the depicted dashboard reached by the vent. The user adjusts the aiming point by swiping in a direction on the screen to shift the aiming point in a selected direction (e.g. up a lot and to the left a little).

While useful and advantageous over many alternatives, the existing system has several disadvantages. The user may have difficulty assessing an actual aiming point based on x and y axis coordinates over a dashboard, or based on an unfamiliar and ambiguous animated airstream depiction that may clearly distinguish between up and down but not between subtle aiming different that are important to user comfort. Swiping in a direction can be difficult to arrive at a desired aiming point and require several attempts due to motor lag, requiring the user to pause to detect the new position and assess whether fine tuning is needed. Moreover, motor vehicle controls for important functions requiring extra user attention may be disadvantageous for safety, and difficult to operate precisely when the vehicle is in motion and jarring a user's arm and finger.

In addition, existing ventilation systems lack the ability to provide added user comfort in other respects due to interface limitations, and without regard for useful environmental and user information that may be available.

The preferred embodiment overcomes these limitations by providing a vehicle ventilation system with a frame and an aimable airflow source associated with the frame. The airflow source is operable to generate an airflow impingement point and is operable to direct the airflow impingement point over a range of airflow aiming directions. An occupant support surface is configured to position an occupant within the range of aiming directions, and an occupant interface device having a graphical display and an occupant input facility is provided. A controller is operably connected to the graphical display and to the airflow source. The graphical display may be operable to depict a representation of the occupant, and to depict a representation of the impingement point juxtaposed at a selected position on the representation of the occupant. A camera may be connected to the controller and operable to generate an image of the occupant, and wherein the airflow impingement point on the occupant is based at least in part on the generated image. The occupant input facility may be an audio-based voice control facility or a touchscreen.

### BRIEF DESCRIPTION OF THE DRAWINGS

FIG. 1 shows an automobile 10 with an interior having a dashboard 12 with driver vent aperture 14, passenger vent aperture 16, and a touchscreen display screen 20. A driver ventilation aiming device 22 is associated with aperture 14, and a passenger vent aiming device 24 is associated with aperture 16, each to provide an aimable ventilation airstream to the respective driver 25 seated in driver seat 26 and passenger 28 in seat 30. A controller 32 is connected to the aiming devices, screen 20, and a cabin camera 34 mounted adjacent the interior rear-view mirror to image a wide view of both occupants in the front seat.

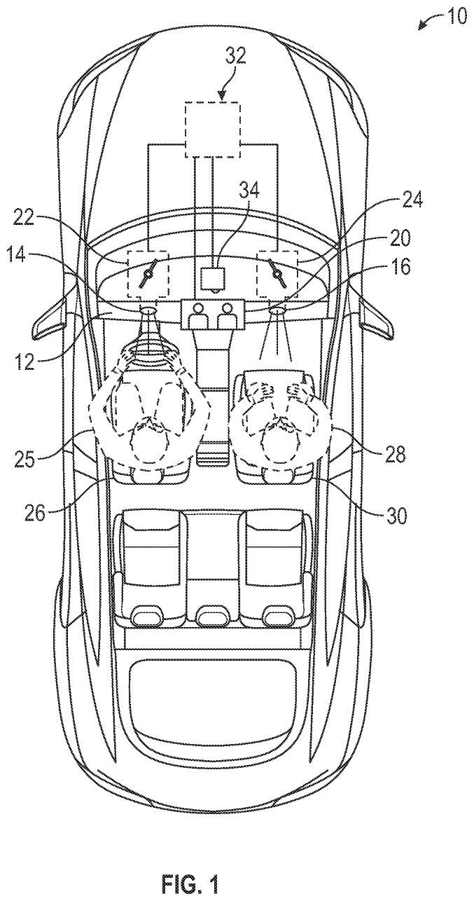

FIG. 2 shows a view from the camera showing driver and passenger (which would actually be photographically realistic and not the simplified view shown) and seats. A sunlit illuminated area 36 is depicted and will be discussed below.

FIG. 3 shows the display screen 20 with a user interface providing a driver representation or FIG. 125 and passenger representation or FIG. 128, amidst many other typical control icons. The representation of occupants 125, 128 may be simple silhouettes showing little more than head, neck and shoulders, or may be pre-loaded images of the actual occupants from preloaded images associated with a driver profile, or from current or recent images captured by the camera.

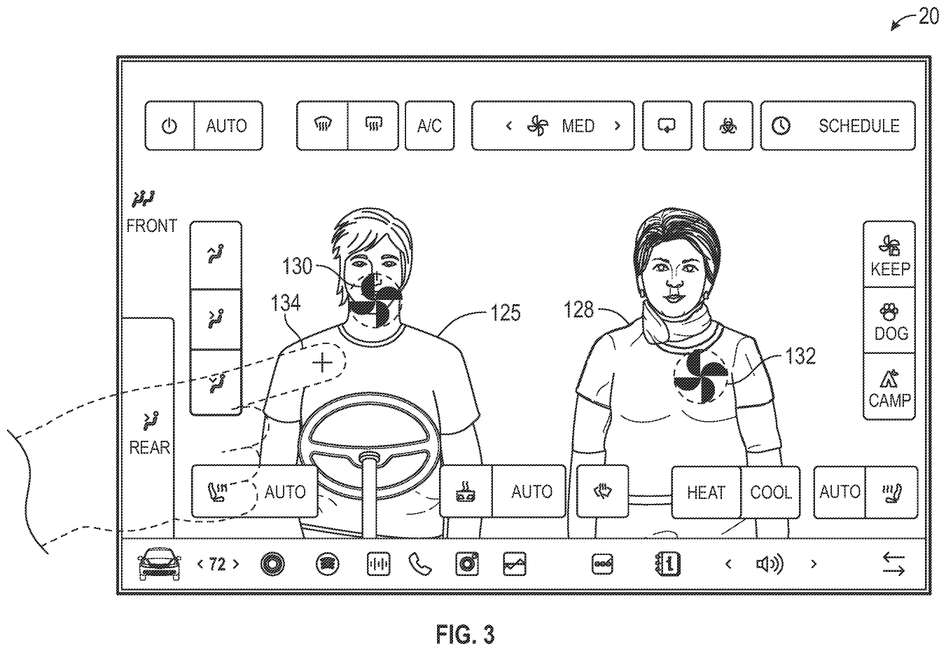

### DETAILED DESCRIPTION OF A PREFERRED EMBODIMENT

Use all information about the invention in the provisional application in this section. On each occupant image or figure is depicted an intended aiming point 130, 132, here shown as a fan icon. This indicates an intended aiming point for the perceived center of the airflow stream on each occupant. The aiming point may be located in a wide range of locations over the area of the depicted figure. It is selected by touching the screen at the desired location in the preferred embodiment as indicated by user finger 134, or by dragging the aiming point to a desired location. In the depicted example, the driver has the aiming point set at his lower face or chin, and the passenger has the aiming point set at her upper chest, right of center (with an effective mirror image of the occupants believed to be most natural for intuitive interface).

Because not all occupants have their body parts in the same position in the car due to different size people and different seat positions, some form of calibration is preferably provided to enable each occupant to intuitively operate the system with the depicted figure accurately indicating the point of impingement on their own body.

One calibration method involves having the occupant initially after establishing a seating position to manually adjust by moving the aiming point on the screen to steer the actual impingement point to an advised reference point such as the nose or center of face. This may be done without the figure on the screen being displayed to avoid confusion, and with an instruction: “Move the fan symbol until air is blowing directly on your nose”. Once complete, the system displays the figure, and subsequently adjustments are then made with this as a zero point of reference.

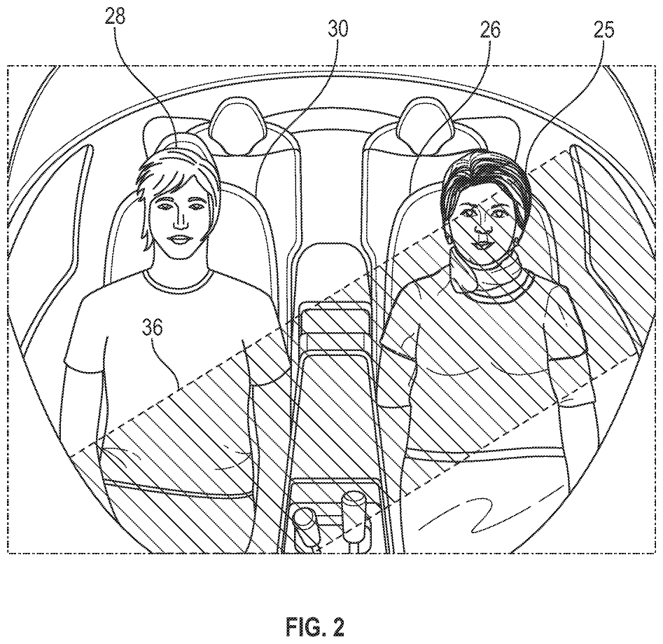

An alternative calibration method would be to use the camera image of FIG. 2 and determine the center of face nose location for the occupant in the orthogonal grid or array of adjustable aiming points. Because of the viewing angle, some factory characterization of the difference between a visual reference point on the seatback (e.g. the midline at the bottom of the headrest) and the occupant's presumed facial center may be adjusted for. Data from fleet users and comparing their desired adjustments to collected images may provide further characterization. To adjust for unexpected minor errors, the occupant may “trim” the system's attempted central position with manual adjustments on the screen.

The system may be responsive to calibrate or aim based on seat position, optionally adjusting the calibration point automatically as the seat position is adjusted for a given occupant. For infrequent guests, the seat position selected may be used with fleet data to infer an expected face location that provides satisfactory calibration, enabling guest occupants to make intuitive adjustments. Image data to assess occupant size and face location may also be employed.

When properly calibrated by user, camera, or remote expert system, the point on the screen selected by the user will be the point of actual perceived location of air flow impingement on the occupant's body. Ease of use is facilitated because of the presumably natural relation of body parts (e.g. brow, chin, cars, chest) to a facial center point.

Additional features may pe provided for added comfort. An occupant may select more than one location, so that the system may alternate between or among those locations to avoid “brain freeze” while a chest is heated up by sunlight streaming through the windshield on a hot day, for instance. The system may jump between the two or more selected location, or may follow a smooth path as it transitions or circulates more slowly around a circuit of locations.

The system may have some pre-programmed aiming point circulation patterns that have been found to be desirable in certain circumstances, and a menu of these may be offered. These may be based in part on the occupant position determination made above during calibration or camera vision, so that a popular and comfortable pattern (e.g. triangular sweep from forehead, to shoulder, to other shoulder and back to forehead, repeating) is scaled and located for the occupant.

With the fan icon depicted in a prominent and in a known location, other functions may be provided by manipulating the icon more than just its location, such as dual-finger pinching or spreading motions to reduce or increase fan speed respectively.

The system may also be used for special circumstances such as maximizing airflow from front vents toward the rear seating area to supplement rear seat air conditioning for a child in a safety seat that impairs normal ventilation, and the optimum aiming location once determined may be memorized for later access.

In embodiments without the graphic depiction map of occupant figures for aiming selection, the system may operate effectively with voice commands in which an occupant requests aiming toward a selected location on their body (e.g. “Aim toward the left side of my face” “my left shoulder it hot”). This is different from and may be advantageous over existing directional voice commands that simply adjust direction without reference to an intended body portion target location (e.g. “aim higher”), because direction commands are difficult to execute with the desired degree of movement.

The system may also employ the camera to identify occupant body portions that are in direct sunlight and likely to be overheating. This is shown in FIG. 2 as sunbeam 36, which covers the driver's chest and occupant's lap. This feature may even determine the effect of clothing material identified in the image by the controller (e.g. thin dark shirt). In these circumstances it may offer to cool those areas, or to occasionally cycle the aiming point to those areas. The camera may further include infra-red or other temperature sensors to locate hot (or cold) spots and “chill” them down. These functions may be available as optional selectable features in a menu to avoid needless unwanted cycling not desired by some occupants.

The system may also be used for vehicle comfort preparation when vacant. When in “Keep Climate” or “Dog Mode” in which the climate control system is operated to keep the vehicle at a selected comfortable temperature in extreme exterior temperature conditions when parked, the aiming point may be directed to a different location than the location preferred by the last occupant. For instance, instead of pointing toward the headrest for facial cooling preferred by an occupant, the aiming point for Keep Climate Mode may be on the lower lumbar region of the seatback to supplement seat cooling in a location more likely to need added cooling to receive a part of the arriving occupant that it likely to be overheated.

The sunlit-area identifying camera capability (sunbeam chaser) may also enable the aiming point to direct toward hot sunlit seat or other interior areas that will be relatively overheated even in Keep Climate mode. Based on observed sunbeam movements, the aiming point may adjust to tack the sunbeam. The aiming point may also generally circulate to different locations, and to selected locations (like a back seat in preparation for children in rear facing car seats that are generally inadequately ventilated) may be prioritized to provide a back seat chill mode in which the front ventilation bypasses from seats to focus on the back seat area.

1. A vehicle ventilation system comprising:
a frame;
an aimable airflow source associated with the frame, operable to generate an airflow impingement point and operable to direct the airflow impingement point over a range of airflow aiming directions;
an occupant support surface configured to position an occupant within the range of aiming directions;
an occupant interface device having a graphical display and an occupant input facility;
a controller operably connected to the graphical display and to the airflow source;
the graphical display being operable to depict a representation of the occupant, and to depict a representation of the impingement point juxtaposed at a selected position on the representation of the occupant.

2. The system of claim 1 wherein the representation of the impingement point juxtaposed on the representation of the occupant on the selected position is based on a determined actual impingement point on the occupant.

3. The system of claim 2 wherein the actual impingement point on the occupant is determined by a calibration process with the occupant.

4. The system of claim 3 wherein the calibration process includes the occupant adjusting the airflow impingement point to a reference point.

5. The system of claim 4 wherein the reference point is a selected central location on the occupant's face.

6. The system of claim 3 wherein the occupant support surface has a seating position adjustment facility connected to the controller and the calibration process includes determining a seating position associated with the seating position adjustment facility.

7. The system of claim 1 including a camera connected to the controller and operable to generate an image of the occupant, and wherein the airflow impingement point on the occupant is based at least in part on the generated image.

8. The system of claim 1 including a camera connected to the controller and operable to generate an image of the occupant, and wherein the depicted representation of the occupant is based at least in part on the generated image.

9. The system of claim 8 wherein the depicted representation of the occupant is a photographic image generated by the camera that identifiably depicts the occupant.

10. The system of claim 1 wherein the aimable airflow source is operable to direct the airflow impingement point to an airflow aiming direction based on a user selection on the occupant input facility.

11. The system of claim 10 wherein the depicted representation of the occupant includes a plurality of depicted occupant body locations, and wherein the airflow aiming direction is toward an actual occupant body location corresponding to a depicted body location.

12. The system of claim 11 wherein the depicted body locations include occupant head, neck, chest, and shoulders.

13. The system of claim 1 including a camera connected to the controller and operable to generate an image of the field associated with the occupant support surface, and the controller is operable to detect a sunlit location, and wherein the controller is operable to direct the airflow impingement point to the sunlit location.

14. The system of claim 1 wherein the controller is operable to direct the airflow impingement point to a first location when the occupant is present, and to a different second location when the occupant support surface is vacant.

15. The system of claim 14 wherein the second location is a sunlit area of the occupant support surface.

16. A vehicle ventilation system comprising:
a frame;
an aimable airflow source associated with the frame, operable to generate an airflow impingement point and operable to direct the airflow impingement point over a range of airflow aiming directions;
an occupant support surface configured to position an occupant within the range of aiming directions;
an occupant input facility operable to receive an airflow impingement point command from the occupant;
a camera operable to generate an image of the occupant;
a controller operably connected to the airflow source, to the occupant input facility, and to the camera;
based on the image and the command, the controller being operable to direct the airflow impingement point to a location selected by the command.

17. The system of claim 16 wherein the command includes at least one of a direction and an occupant body location.

18. The system of claim 16 wherein the occupant input facility is an audio-based voice control facility.

19. A vehicle ventilation system comprising:
a frame;
an aimable airflow source associated with the frame, operable to generate an airflow impingement point and operable to direct the airflow impingement point over a range of airflow aiming directions;
an occupant support surface configured to position an occupant within the range of aiming directions;
an occupant input facility operable to receive an airflow impingement point command from the occupant indicating a body location on the occupant;
a controller operably connected to the airflow source and to the occupant input facility;
based on the command, the controller being operable to direct the airflow impingement point to a location associated with the body location.

20. The system of claim 19 wherein the occupant input facility is an audio-based voice control facility.
